(19) United States
(12) Patent Application Publication
(10) Pub. No.: US 2026/0051481 A1
(43) Pub. Date: Feb. 19, 2026

(54) SILICON-BASED NEGATIVE ELECTRODE ACTIVE MATERIAL AND MANUFACTURING METHOD THEREFOR

(71) Applicant: THE INDUSTRY &ACADEMIC COOPERATION IN CHUNGNAM NATIONAL UNIVERSITY (IAC), Daejeon (KR)

(72) Inventors: Sung-Soo Kim, Daejeon (KR); Seonghyeon Lim, Daejeon (KR); Nurzhan Umirov, Daejeon (KR); Mukhan Orynbassar, Daejeon (KR); Byoung-Min Lee, Anyang-si, Gyeonggi-do (KR); Jae-Hak Choi, Daejeon (KR)

(21) Appl. No.: 19/100,459

(22) PCT Filed: Jul. 27, 2023
(86) PCT No.: PCT/KR2023/010914

§ 371 Date: Jan. 31, 2025

(30) Foreign Application Priority Data
Aug. 1, 2022 (KR) 10-2022-0095328

(51) Int. Cl. H01M 4/36; H01M 4/48; H01M 4/587

(52) U.S. Cl. CPC H01M 4/366; H01M 4/48; H01M 4/587

(57) ABSTRACT

A negative electrode active material comprises: a core which contains a porous silicon-based material; and a coating layer which contains amorphous carbon and coats the surface of the core. The coating layer coating the surface of the core satisfies 1<R₁/R₂<3, in which R₁ indicates the ratio (I_{D1}/I_{G}) of the central peak intensity I_{D1} of D1 band and the central peak intensity I_{G} of G band, and R₂ indicates the ratio (I_{D3}/I_{G}) of the central peak intensity I_{D3} of D3 band and the central peak intensity I_{G} of the G band, wherein the D1 band has a peak center in the wavenumber range of 1350 20 cm⁻¹, the G band has a peak center in the wavenumber range of 1600 20 cm⁻¹, and the D3 band has a peak center in the wavenumber range of 1500±10 cm⁻¹ in the Raman spectrum.

### TECHNICAL FIELD

The present invention relates to a silicon-based negative electrode active material and a method for manufacturing the same, and more particularly, to a silicon-based negative electrode active material which may provide an excellent capacity retention rate by effectively suppressing a volume change of silicon occurring during a charging/discharging process of a secondary battery and a method for manufacturing the same.

### BACKGROUND ART

In recent years, a demand for a secondary battery which has improved life characteristics to allow long-term use along with high energy density properties in various industrial fields such as electric or hybrid vehicles and aerospace as well as portable electronic devices is increasing.

Generally, graphite is mainly used as a representative negative electrode material which is included in a negative electrode of a secondary battery composed of a positive electrode, a negative electrode, an electrolyte, and a separator and commercially used, but the graphite only has a capacity per unit mass of 372 mAh/g.

A negative electrode active material showing a higher capacity than graphite, for example, a material which electrochemically forms an alloy with lithium, such as silicon, tin, and oxides thereof, shows a high capacity of about 1000 mAh/g or more, and in particular, since the theoretical maximum capacity of silicon is 4,200 mAh/g and the theoretical maximum capacity of silicon oxides is 1,500 mAh/g, a study intended to use a silicon-based material as a negative electrode material is actively in progress.

However, the silicon-based negative electrode active material causes a change in a crystal structure when electrochemically forming an alloy with lithium and changes a volume by 300% or more. In this case, defects such as physical peeling or an increase in contact resistance between negative electrode active materials or a negative electrode active material and a current collector during charging and discharging occur to rapidly cause deterioration of secondary battery capacity as a charge/discharge cycle progresses.

In order to solve the problem, a technology of nanosizing silicon into a wire form and the like and compositing it with a carbon material has been suggested, but initial charge and discharge efficiency, cycle characteristics, high-rate properties, or the like are still lowered to make commercialization difficult.

Thus, for the higher capacity of a secondary battery, there is a need to develop a silicon-based negative electrode active material showing an excellent capacity retention rate with improved cycle life characteristics by effectively controlling a volume change.

### DISCLOSURE

### Technical Tasks

An object of the present invention is to provide a negative electrode active material having an excellent battery capacity and excellent cycle life characteristics.

Another object of the present invention is to provide a method for manufacturing a negative electrode active material which may effectively suppress a volume change of a negative electrode occurring during a charging and discharging process.

### Technical Solution

In one general aspect, a negative electrode active material includes: a core including a porous silicon-based material; and a coating layer including an amorphous carbon coated on a surface of the core, wherein the coating layer satisfies the following Relation Expression 1:

$$1 < {R}_{1} / {R}_{2} < 3 \qquad ( Relational Expression 1 )$$

wherein R₁ is a ratio (I_{D1}/I_{G}) of a central peak intensity I_{D1} of a D1 band and a central peak intensity I_{G} of a G band, and Ra is a ratio (I_{D3}/I_{G}) of a central peak intensity I_{D3} of a D3 band and the central peak intensity I_{G} of the G band, the D1 band having a peak center positioned in a wave number range of 1350±20 cm⁻¹, the G band having a peak center positioned in a wave number range of 1580±20 cm⁻¹, and the D3 band having a peak center positioned in a wave number range of 1500±10 cm⁻¹, in a Raman spectrum.

In the negative electrode active material according to an exemplary embodiment of the present invention, the amorphous carbon may be derived from a resin having a repeating unit containing an arylene group.

In the negative electrode active material according to an exemplary embodiment of the present invention, the resin may have a repeating unit containing one or more phenolic hydroxyl groups.

In the negative electrode active material according to an exemplary embodiment of the present invention, a hydroxyl group equivalent included in the resin may be 150 to 300 g/eq.

In the negative electrode active material according to an exemplary embodiment of the present invention, R₁ may be 0.9 to 1.05.

In the negative electrode active material according to an exemplary embodiment of the present invention, R₂ may be 0.5 to 0.6.

In the negative electrode active material according to an exemplary embodiment of the present invention, the silicon-based material may include at least one material of silicon (Si), a silicon oxide (SiOₓ(0<x≤2)), a silicon alloy, or a combination thereof.

In the negative electrode active material according to an exemplary embodiment of the present invention, the silicon-based material may include 30 at % or more of silicon having an oxidation number of 4 in a Si 2P XPS spectrum of the negative electrode active material including deconvoluted peaks corresponding to silicon having the oxidation number of 0, 1, 2, 3, and 4.

In the negative electrode active material according to an exemplary embodiment of the present invention, the silicon-based material may satisfy the following Relational Expression 2:

$${A}_{4} / {A}_{1} \geq 4 \qquad ( Relational Expression 2 )$$

wherein A₄ is the atom % of silicon having an oxidation number of 4, and A₁ is the atom % of silicon having an oxidation number of 1, in the Si 2P XPS spectrum of the negative electrode active material.

In the negative electrode active material according to an exemplary embodiment of the present invention, the coating layer may have a thickness of 5 to 30 nm.

In the negative electrode active material according to an exemplary embodiment of the present invention, the core may have an average diameter of 0.1 to 50 μm.

In another general aspect, a negative electrode for a secondary battery includes the negative electrode active material described above.

In still another general aspect, a method for manufacturing a negative electrode active material is provided.

The method for manufacturing a negative electrode active material according to the present invention may include: a) preparing a coating solution including a resin having a repeating unit containing an arylene group and a solvent, for forming a coating layer including amorphous carbon; b) preparing a first mixture of porous silicon-based powder in the coating solution; and c) drying and then heat treating the first mixture.

In the method for manufacturing a negative electrode active material according to an exemplary embodiment of the present invention, the coating solution may have a viscosity of 5 to 200 cP.

In the method for manufacturing a negative electrode active material according to an exemplary embodiment of the present invention, a weight ratio of the coating solution: the silicon-based powder may be 1:8 to 15.

In the method for manufacturing a negative electrode active material according to an exemplary embodiment of the present invention, the resin included in the coating solution may have a repeating unit containing one or more phenolic hydroxyl groups.

In the method for manufacturing a negative electrode active material according to an exemplary embodiment of the present invention, the heat treating of c) may be performed in a temperature condition of 900 to 1100° C. under an inert gas atmosphere.

In the method for manufacturing a negative electrode active material according to an exemplary embodiment of the present invention, using the product obtained after the heat treating of c), a unit process including: b-1) preparing a second mixture of the product in the coating solution; and c-1) drying and then heat treating the second mixture may be performed once or more.

In the method for manufacturing a negative electrode active material according to an exemplary embodiment of the present invention, in a first coating layer of the product obtained after c) to an N^{th} coating layer of the product obtained by performing the unit process n times or more, standard deviations of an R₁ value and an R₂ value of the first coating layer to the N^{th} coating layer may be less than 0.1, respectively.

Herein, R₁ is a ratio (I_{D1}/I_{G}) of a central peak intensity I_{D1} of a D1 band and a central peak intensity I_{G} of a G band, and R₂ is a ratio (I_{D3}/I_{G}) of a central peak intensity Ips of a D3 band and the central peak intensity I_{G} of the G band, the D1 band having a peak center positioned in a wave number range of 1350±20 cm⁻¹, the G band having a peak center positioned in a wave number range of 1580±20 cm⁻¹, and the D3 band having a peak center positioned in a wave number range of 1500±10 cm⁻¹, in a Raman spectrum.

### Advantageous Effects

The negative electrode active material according to an exemplary embodiment of the present invention includes a core including a porous silicon-based material and a coating layer including amorphous carbon coated on a surface of the core, and since the coating layer satisfies the following Relational Expression 2, a discharge capacity is excellent and a volume change of a negative electrode occurring during a charging and discharging process is effectively suppressed, thereby providing a significantly improved cycle life characteristics:

$$1 < {R}_{1} / {R}_{2} < 3 \qquad ( Relational Expression 1 )$$

wherein R₁ is a ratio (I_{D1}/I_{G}) of a central peak intensity I_{D1} of a D1 band and a central peak intensity I_{G} of a G band, and R₂ is a ratio (I_{D3}/I_{G}) of a central peak intensity I_{D3} of a D3 band and the central peak intensity I_{G} of the G band, the D1 band having a peak center positioned in a wave number range of 1350±20 cm⁻¹, the G band having a peak center positioned in a wave number range of 1580±20 cm⁻¹, and the D3 band having a peak center positioned in a wave number range of 1500±10 cm⁻¹, in a Raman spectrum.

### DESCRIPTION OF DRAWINGS

FIG. 1 is a drawing showing results of X-ray diffraction (XRD) analysis of a negative electrode active material prepared according to an exemplary embodiment.

FIG. 2 is a drawing showing a transmission electron microscope (TEM) image of the negative electrode active material prepared according to an exemplary embodiment.

(a) and (b) of FIG. 3 are drawings showing Raman spectrum measured for each of the carbon coating layers included in the negative electrode active materials of Comparative Examples 1 and 2 and Examples 1 to 3, and results of the Raman spectrum showing deconvoluted peaks fitted from the measured Raman spectrum.

(a), (b), and (c) of FIG. 4 are drawings showing high resolution Si 2P XPS profiles including deconvoluted peaks corresponding to silicon having an oxidation number of 0, 1, 2, 3, and 4 for the negative electrode active materials of Example 1 and Comparative Examples 1 and 2, respectively.

(a) and (b) of FIG. 5 are drawings showing high resolution C 1s XPS profiles of the negative electrode active materials prepared according to Example 1 and Comparative Example 2, respectively.

(a) and (b) of FIG. 6 are drawings showing results of charge and discharge cycle life characteristics and rate properties of a battery including the negative electrode active material prepared according to an exemplary embodiment, respectively.

### EMBODIMENTS

Hereinafter, the negative electrode active material according to an exemplary embodiment of the present invention will be described in detail with reference to the attached drawings. The drawings to be provided below are provided by way of example so that the spirit of the present invention may be sufficiently transferred to a person skilled in the art.

Therefore, the present invention is not limited to the drawings provided below but may be embodied in many different forms, and the drawings suggested below may be exaggerated in order to clarify the spirit of the present invention. Technical terms and scientific terms used herein have the general meaning commonly understood by a person skilled in the art to which the present invention pertains unless otherwise defined, and description for the known function and configuration which may unnecessarily obscure the gist of the present invention will be omitted in the following description and the accompanying drawings.

In addition, the singular form used in the specification and claims appended thereto may be intended to include a plural form also, unless otherwise indicated in the context.

In the present specification and the appended claims, the terms such as first, second, and N^{th} are not used in a limited meaning but are used for the purpose of distinguishing one constituent element from other constituent elements.

In the present specification and the appended claims, the terms such as “comprise” or “have” mean that there is a characteristic or a constitutional element described in the specification, and as long as it is not particularly limited, a possibility of adding one or more other characteristics or constitutional elements is not excluded in advance.

In the present specification and the appended claims, when a portion such as a layer (membrane), an area, and a constituent element is present on another portion, not only a case in which the portion is in contact with and directly on another portion but also a case in which other layers (membranes), other areas, other constituent elements, and the like are interposed between the portions is included.

The negative electrode active material according to an exemplary embodiment of the present invention includes: a core including a porous silicon-based material; and a coating layer including an amorphous carbon coated on a surface of the core, wherein the coating layer coated on the surface of the core satisfies the following Relation Expression 1:

$$1 < {R}_{1} / {R}_{2} < 3 \qquad ( Relational Expression 1 )$$

wherein R₁ is a ratio (I_{D1}/I_{G}) of a central peak intensity I_{D1} of a D1 band and a central peak intensity I_{G} of a G band, and R₂ is a ratio (I_{D3}/I_{G}) of a central peak intensity I_{D3} of a D3 band and the central peak intensity I_{G} of the G band, the D1 band having a peak center positioned in a wave number range of 1350±20 cm⁻¹, the G band having a peak center positioned in a wave number range of 1600±20 cm⁻¹, and the D3 band having a peak center positioned in a wave number range of 1500±10 cm⁻¹, in a Raman spectrum.

The negative electrode active material according to an exemplary embodiment of the present invention includes a silicon-based material, but is provided with a coating layer including amorphous carbon coated on the surface of the core, which has the Raman properties described above, and thus, effectively suppresses a volume change of a silicon-based material in a charge and discharge process unlike a conventional silicon-based negative electrode active material, thereby having excellent cycle life characteristics.

In addition, since the coating layer is uniformly placed on the surface of the core including the porous silicon-based material, the electrical conductivity properties of the surface of the negative electrode active material may be improved. Herein, the coating layer which is uniformly placed on the surface of the core may include a coating layer placed inside pores included in the porous silicon-based material.

As an exemplary embodiment, the amorphous carbon included in the coating layer may be derived from a resin having a repeating unit containing an arylene group.

As a specific example, the arylene group included in the resin may be a C6 to C20 arylene group, and hydrogen of the arylene group may be substituted by a C1-C4 alkyl group. The arylene group may be specifically a phenylene group.

As a specific example, the resin having the repeating unit containing an arylene group may have a repeating unit containing a phenolic hydroxyl group, and the hydroxyl group equivalent included in the resin may be 100 to 500 g/eq, specifically 150 to 300 g/eq, and more specifically 200 to 250 g/eq.

Specifically, the resin having the characteristics described above is included in the coating solution with a solvent in the method for manufacturing a negative electrode active material described later, and the resin is formed into the coating layer including amorphous carbon coated on the surface of the core including the porous silicon-based material by a heat treatment process, after mixing the coating solution with the porous silicon-based material. Herein, since the resin included in the coating solution satisfies the characteristics described above, the coating layer is uniformly placed on the surface of the core including the porous silicon-based material and also may satisfy the Raman properties described above. The resin will be described in detail in terms of the method for manufacturing a negative electrode active material described later.

As a specific example, the coating layer including amorphous carbon may have a thickness of 5 to 50 nm, substantially 5 to 30 nm, more substantially 5 to 15 nm, and still more substantially 8 to 12 nm.

In order to effectively suppress a volume change of the core including the porous silicon-based material and also improve the electrical conductivity properties of the surface of the negative electrode active material, it is favorable that the thickness of the coating layer including amorphous carbon satisfies the range described above.

As an example, the negative electrode active material may include 1.5 to 20 wt %, specifically 1.8 to 15 wt %, and more specifically 2.0 to 10 wts of the amorphous carbon.

Herein, the amorphous carbon may be carbon which satisfies Raman properties in a range of 0.5<I_{D1}/I_{G}<1.2, the I_{D1}/I_{G} being a ratio (I_{D1}/I_{G}) of a central peak intensity I_{D1} of a D1 band having a peak positioned around 1350 cm⁻¹ and a central peak intensity Is of a G band having a peak positioned in an area of about 1580 cm⁻¹, in a Raman spectrum.

In general, in the Raman spectrum of a carbon-based material, the central peak of the D1 band is a peak shown by disorder of sp2 carbon, and as the central peak intensity of the D1 band is higher, crystallinity may be interpreted as being low by the existing defect, and as the central peak intensity of the D1 band is lower, crystallinity may be interpreted as being high.

In a specific example, the coating layer including amorphous carbon may satisfy the following Relation Expression 1:

$$1 < {R}_{1} / {R}_{2} < 3 \qquad ( Relational Expression 1 )$$

wherein R₁ is a ratio (I_{D1}/I_{G}) of a central peak intensity I_{D1} of a D1 band and a central peak intensity I_{G} of a G band, and Ra is a ratio (I_{D3}/I_{G}) of a central peak intensity I_{D3} of a D3 band and the central peak intensity I_{G} of the G band, the D1 band having a peak center positioned in a wave number range of 1350±20 cm⁻¹, the G band having a peak center positioned in a wave number range of 1580±20 cm⁻¹, and the D3 band having a peak center positioned in a wave number range of 1500±10 cm⁻¹, in a Raman spectrum.

Herein, the central peak of the D1 band, the central peak of the D3 band, and the central peak of the G band are fitted from the obtained Raman spectrum but may be deconvoluted peaks corresponding to each wave number range described above.

Specifically, since the coating layer including amorphous carbon satisfies the Raman properties described above and is uniformly placed on the surface of the core including the porous silicon-based material, a volume change of the porous silicon-based material included in the negative electrode active material is effectively suppressed, and also the electrical conductivity properties of the surface of the negative electrode active material may be improved.

As a specific example, Relational Expression 1 (R₁/R₂) may be 1.3 or more, 1.4 or more, 1.5 or more, or 1.6 or more and substantially 2.5 or less, 2.3 or less, 2.0 or less, or 1.9 or less.

As an exemplary embodiment, R; may be 0.87 to 1.10, specifically 0.9 to 1.05, and more specifically 0.93 to 1.02, and R₂ may be 0.45 to 0.65, specifically 0.5 to 0.6, and more specifically 0.52 to 0.59.

In an exemplary embodiment, the coating layer including amorphous carbon may include carbon having a C—C bond structure, a C—O bond structure, a C═O bond structure, and a O—C═O bond structure. Herein, the carbon having the bond structures described above may be derived from a high resolution C 1s XPS profile of the negative electrode active material measured using X-ray photoelectron spectroscopy (XPS).

As a specific example, the coating layer including amorphous carbon may include 65 at % or more, 66 at % or more, or 67 at % or more of carbon having a C—C bond structure and include substantially 80 at % or less of carbon having a C—C bond structure. As such, the negative electrode active material including carbon having a sp² bond structure, that is, carbon having a C—C bond structure in a range satisfying the above, may improve the electrical conductivity properties on the surface of the negative electrode active material.

As a specific example, a ratio (C2/C1) of at % (C2) of carbon having a C—C bond structure to at % (C1) of carbon having a O—C═O bond structure may be 10 or more, 11 or more, 12 or more, 12.5 or more and substantially 15 or less.

As an exemplary embodiment, the core including the porous silicon-based material on which the coating layer including amorphous carbon described above is coated may be particulate, and the particulate core may have an average diameter of 0.1 to 50 μm, specifically 0.5 to 30 μm, and more specifically 0.5 to 20 μm. Herein, the average diameter of the core may be a particle diameter at 50% of the particle diameter distribution of the particulate core, and the core may be a single particle formed of the porous silicon-based material and may include an agglomerate of single particles, of course.

The porous silicon-based material included in the core may have a Brunauer-Emmett-Teller (BET) surface area of 0.5 to 20 m²/g, specifically 1 to 10 m²/g, and more specifically 1 to 5 m²/g.

As an exemplary embodiment, the silicon-based material included in the core may include at least one material of silicon (Si), a silicon oxide (SiOₓ(0<x≤2)), a silicon alloy, and a combination thereof, and the silicon alloy may include, for example, a material selected from an alkali metal, an alkaline earth metal, a Group 13 element, a Group 14 element other than Si, a transition metal, a rare earth element, or a combination thereof.

Herein, the silicon-based material, such as silicon, a silicon oxide, and a silicon alloy may include amorphous silicon, crystalline silicon, or a mixed form thereof, and the porous silicon-based material may be specifically a silicon oxide (SiOₓ, x is more than 0 and less than 2), and more specifically a composite oxide of one or more doping elements selected from the group consisting of alkali metals, alkaline earth metals, and post-transition metals with silicon, but the present invention is not limited thereto.

As a non-limiting example, the doping element may be one or more selected from lithium (Li), sodium (Na), potassium (K), rubidium (Rb), cesium (Cs), beryllium (Be), magnesium (Mg), calcium (Ca), strontium (Sr), barium (Ba), aluminum (Al), gallium (Ga), indium (In), tin (Sn), and bismuth (Bi).

As a specific example, the silicon-based material may include 30 at % or more of silicon having an oxidation number of 4 in a Si 2P XPS spectrum of the negative electrode active material described above including deconvoluted peaks corresponding to silicon having the oxidation number of 0, 1, 2, 3, and 4.

Herein, the peak corresponding to silicon having the oxidation number of 0 among the deconvoluted peaks included in the Si 2P XPS spectrum may be a peak positioned in a binding energy range of 98 to 100 eV, and the peaks corresponding to silicon having the oxidation number of 1, 2, 3, and 4 may refer to peaks positioned in binding energy ranges of 100.5 to 101.5 eV, 101.6 to 102.5 eV, 102.6 to 103.5 eV, and 103.6 to 104.5 eV, respectively.

In addition, a peak being positioned in the binding energy range described above means that a maximum intensity value position in the corresponding peak is within the binding energy range.

As a favorable example, the silicon-based material may include 30 at % or more, 35 at % or more, 36 at % or more, 37 at % or more, 38 at % or more, 39 at % or more, or 40 at % or more and substantially 60 at % or less and more substantially 55 at % or less of silicon having the oxidation number of 4 in the Si 2P X-ray photoelectron spectroscopy (XPS) spectrum of the negative electrode active material described above.

In the negative electrode active material including the silicon-based material on which the coating layer including amorphous carbon is coated, since the silicon-based material includes silicon having the oxidation number of 4 in the range described above in the Si 2P X-ray photoelectron spectroscopy (XPS) spectrum of the negative electrode active material, a volume change of the silicon-based material is effectively suppressed in the charging and discharging process, thereby having excellent cycle life characteristics and also providing excellent battery capacity characteristics.

As a specific example, the silicon-based material may satisfy the following Relation Expression 2:

$${A}_{4} / {A}_{1} \geq 4 \qquad ( Relational Expression 2 )$$

wherein A₄ is the atom % of silicon having an oxidation number of 4, and A₁ is the atom % of silicon having an oxidation number of 1, in the Si 2P XPS spectrum of the negative electrode active material.

As an example, a ratio (A₄/A₁) of the atom % of silicon having the oxidation number 4 to at % of silicon having the oxidation number of 1 in the Si 2P XPS spectrum of the negative electrode active material may be 4 or more, 5 or more, 6 or more, 7 or more, or 8 or more and substantially 10 or less.

As the negative electrode active material includes more silicon having the oxidation number of 4, battery capacity characteristics may be improved, but since there is a limitation to suppressing a volume change in a charging and discharging process, in order to provide excellent battery capacity characteristics and also more effectively suppress the volume change of the negative electrode in the charging and discharging process, it is favorable for the silicon-based material to satisfy Relation Expression 2.

The present invention provides a negative electrode for a secondary battery including the negative electrode active material described above.

Herein, the negative electrode may be a negative electrode of a secondary battery, specifically a lithium secondary battery. The negative electrode may include a current collector; and a negative electrode active material layer which is placed on at least one surface of the current collector and contains the negative electrode active material described above, and the negative electrode active material layer may further include a binder and a conductive material which are commonly used in the negative electrode active material and the negative electrode for a secondary battery, if necessary.

In addition, the present invention includes a secondary battery including the negative electrode described above. Specifically, the present invention includes a lithium secondary battery including the anode described above. The lithium secondary battery may include a positive electrode including a positive electrode current collector and a positive electrode active material layer placed on at least one surface of the positive electrode current collector; the negative electrode described above; a separator interposed between the positive electrode and the negative electrode; and an electrolyte which conducts a lithium ion. Herein, since the positive electrode current collector, the negative electrode current collector, the positive electrode active material or the composition of the positive electrode active material layer, the separator, the solvent, the electrolyte salt, or the electrolyte salt concentration of the electrolyte, and the like are any material or composition which is commonly adopted in a lithium secondary battery, the present invention is not limited thereto.

According to another exemplary embodiment, the present invention provides a method for manufacturing a negative electrode active material.

The method for manufacturing a negative electrode active material according to an exemplary embodiment of the present invention includes: a) preparing a coating solution including a resin having a repeating unit containing an arylene group and a solvent, for forming a coating layer including amorphous carbon; b) preparing a first mixture of porous silicon-based powder in the prepared coating solution; and c) drying and then heat treating the first mixture.

The negative electrode active material according to an exemplary embodiment of the present invention is manufactured by a simple process of mixing a coating solution including a resin having a repeating unit containing an arylene group and a solvent with porous silicon-based powder to prepare a first mixture, and then drying and heat treating the first mixture, but a coating layer including amorphous carbon on the surface of the porous silicon-based powder may be formed at a uniform thickness. Herein, the amorphous carbon included in the formed coating layer may be placed in the inside of pores included in the porous silicon-based powder as well as on the surface of the porous silicon-based powder.

Hereinafter, the method for manufacturing a negative electrode active material according to an exemplary embodiment of the present invention will be described in detail for each step.

First, a) a coating solution including a resin having a repeating unit containing an arylene group and a solvent is prepared for forming a coating layer including amorphous carbon.

Herein, the resin having the repeating unit containing an arylene group included in the coating solution may be similar or identical to the above description.

However, since the resin included in the coating solution is formed into the coating layer including amorphous carbon on the surface of the porous silicon-based powder (including pores) through the heat treatment process of step c) described later, a resin having a high carbon content, high flowability, and excellent solubility is preferred as the resin, in order to form a uniform coating layer and uniformly form a coating layer even to pores included in the porous silicon-based powder.

As a favorable example, the arylene group included in the resin for forming the coating layer including amorphous carbon may be a C6 to C20 arylene group, specifically a phenylene group, and more specifically, the resin may have a repeating unit containing one or more phenolic hydroxyl groups, and the hydroxyl group equivalent included in the resin may be 100 to 500 g/eq, specifically 150 to 300 g/eq, and more specifically 200 to 250 g/eq.

When the hydroxyl group equivalent included in the resin is less than 100 g/eq, flowability may be lowered, and when the hydroxyl group equivalent is more than 500 g/eq, uniformity of the coating layer formed after the heat treatment process may be deteriorated, and thus, it is preferred that the hydroxyl group equivalent included in the resin satisfies the range described above.

As a specific example, the resin having a repeating unit containing an arylene group may contain 75 to 95 wt %, specifically 80 to 80 wt % of carbon.

As described above, since the resin having the repeating unit containing an arylene group may have high flowability even with a high content of carbon contained, it may be formed into a uniform coating layer throughout the surface of the silicon-based powder as well as the pores included in the porous silicon-based powder through the heat treatment process.

In an exemplary embodiment, the coating solution prepared for forming the coating layer including amorphous carbon may include the resin described above and the solvent.

Herein, the use of the solvent is not limited as long as the solvent may dissolve the resin described above, and as a specific example, the solvent may be one or more polar solvents selected from the group consisting of distilled water, C1 to C5 straight chain or branched alcohol, acetone, and ethyl acetate.

As a specific example, a weight ratio of the resin having a repeating unit containing an arylene group: the solvent included in the coating solution may be 1:1 to 20, substantially 1:3 to 15, and more substantially 1:5 to 10.

As an example, the coating solution may have a viscosity of 1 to 400 cP, specifically 1 to 250 cP, and more specifically 2 to 200 cP.

Subsequently, b) a first mixture of porous silicon-based powder in the prepared coating solution is prepared.

Herein, since the porous silicon-based powder is identical or similar to the silicon-based material or the core including the silicon-based material described above, the detailed description thereof will be omitted.

As an exemplary embodiment, a weight ratio of the coating solution: the silicon-based powder included in the first mixture may be 1:5 to 20, specifically 1:8 to 15, and more specifically 1:9 to 12. In order to uniformly form the coating layer having a desired thickness on the silicon-based powder through the heat treatment process described later, it is preferred that the weight ratio of the coating solution: the silicon-based powder included in the first mixture satisfies the range described above.

In an exemplary embodiment, the first mixture in which the coating solution: the silicon-based powder are mixed in the weight ratio described above may be prepared by stirring for 5 minutes or more, specifically 10 minutes or more, and more specifically 15 minutes or more, and a time to perform the stirring may be substantially 60 minutes or less, and more substantially 30 minutes or less, but the upper limit of the time to perform the stirring is not limited.

However, when the time of the stirring process is less than 5 minutes, the coating solution is not sufficiently coated on pores included in the porous silicon-based powder as well as the surface of the powder, and thus, it is preferred that the stirring process is performed during the time period described above.

Subsequently, c) the prepared first mixture is dried and then heat treated to prepare a negative electrode active material.

Herein, the coating solution coated on the porous silicon-based powder is uniformly distributed by the drying process performed before the heat treatment, and also the solvent included in the coating solution may be removed.

As a specific example, the drying process may be performed for 0.5 to 5 hours, substantially 1 to 3 hours in a temperature condition of 60 to 150° C., specifically 80 to 130° C., and more specifically 100 to 120° C.

When the temperature is less than 60° C. and/or a performance time is less than 0.5 hours in the drying process performed before the heat treatment, removal of the solvent included in the coating solution may be imperfectly performed, and when the temperature is higher than 150° C. and/or the performance time is more than 5 hours, the uniformity of the coating solution placed on the porous silicon-based powder may be deteriorated, and thus, it is preferred to perform the drying process under the conditions described above.

As an exemplary embodiment, the heat treatment performed after drying the prepared first mixture may be performed in a temperature condition of 800 to 1300° C., specifically 900 to 1100° C. under an inert gas atmosphere. Herein, the inert gas atmosphere may refer to an atmosphere where for example, nitrogen gas, argon gas, helium gas, krypton gas, xenon gas, or the like is present.

As a specific example, the porous silicon-based powder on which the coating layer including amorphous carbon is formed may be heat treated in the temperature range described above for 0.5 to 5 hours, specifically 0.7 to 3 hours, and more specifically 0.8 to 2 hours and then naturally cooled to prepare the negative electrode active material.

Herein, the heat treatment temperature described above may be reached at a heating rate of 0.5 to 10° C./min, substantially 1 to 5° C./min.

In an exemplary embodiment, the characteristics of the silicon-based powder included in the first mixture may be controlled by the heat treatment process described above.

Specifically, when the silicon-based powder is a silicon oxide, the surface chemical properties of the silicon oxide included in the negative electrode active material obtained after the heat treatment process may be shown differently from the surface chemical properties of the silicon oxide included in the first mixture. Herein, the surface chemical properties may be measured by X-ray photoelectron spectroscopy (XPS).

More specifically, the silicon-based material included in the negative electrode active material obtained after the heat treatment process may include 30 at % or more, 35 at % or more, 36 at % or more, 37 at % or more, 38 at % or more, 39 at& or more, or 40 at % or more and substantially 60 at % or less and more substantially 55 at % or less of silicon having the oxidation number of 4 in the Si 2P X-ray photoelectron spectroscopy (XPS) spectrum of the negative electrode active material including the deconvoluted peaks corresponding to silicon having the oxidation number of 0, 1, 2, 3, and 4, and a ratio (A₄/A₁) of the atoms of silicon having the oxidation number of 4 to the atom % of silicon having the oxidation number of 1 in the Si 2P XPS spectrum of the negative electrode active material may be 4 or more, 5 or more, 6 or more, 7 or more, or 8 or more and substantially 10 or less.

Herein, the peak corresponding to silicon having each oxidation number among the deconvoluted peaks included in the Si 2P XPS spectrum is similar or identical to the above description, and the detailed description thereof will be omitted.

As an exemplary embodiment, using the product obtained after the heat treatment of c), that is, the porous silicon-based powder on which the coating layer including amorphous carbon is formed, a unit process including: b-1) preparing a second mixture of the product in the prepared coating solution; and c-1) drying and then heat treating the prepared second mixture, may be performed once or more.

The thickness of the coating layer formed on the surface of the porous silicon-based powder may be easily adjusted according to the number of times the unit process is performed.

As a specific example, the unit process may be performed once or more, twice or more, three times or more, four times or more, or five times or more, and substantially 50 times or less, more substantially 30 times or less.

Herein, though the present invention is not limited to the number of times of the unit process performed, it is preferred that the finally formed coating layer satisfies the Raman properties (Relational Expression 1) described above.

As an example, in the first coating layer of the product obtained after step c) to the N^{th} coating layer of the product obtained by performing the unit process described above n times or more, a standard deviation of R₁ and R₂ values of the first coating layer to the N^{th} coating layer may be less than 0.5, specifically less than 0.3, and more specifically less than 0.1. Herein, N is a natural number, or a natural number satisfying the conditions of 0<N≤20, specifically 0<N≤10, more specifically 0<N≤5, and still more specifically 0<N≤3.

Herein, R₁ is a ratio (I_{D1}/I_{G}) of a central peak intensity I_{D1} of a D1 band and a central peak intensity I_{G} of a G band, and R₂ is a ratio (I_{D3}/I_{G}) of a central peak intensity I_{D3} of a D3 band and the central peak intensity I_{G} of the G band, the D1 band having a peak center positioned in a wave number range of 1350±20 cm⁻¹, the G band having a peak center positioned in a wave number range of 1580±20 cm⁻¹, and the D3 band having a peak center positioned in a wave number range of 1500±10 cm⁻¹, in a Raman spectrum.

Since the negative electrode active material manufactured according to an exemplary embodiment of the present invention includes the coating layer satisfying the Raman properties described above, though the negative electrode active material includes the silicon-based material, it may effectively suppress the volume change of the silicon-based material in the charging and discharging process unlike the conventional silicon-based negative electrode material to have excellent cycle life characteristics, and also the coating layer including amorphous carbon is uniformly placed on the surface of the negative electrode active material, and thus, the electrical conductivity properties of the surface of the negative electrode active material may be improved.

Hereinafter, the negative electrode active material according to an exemplary embodiment of the present invention will be described in more detail by the following examples. However, the following examples are only a reference for describing the present invention in detail, and the present invention is not limited thereto and may be implemented in various forms.

In addition, unless otherwise defined, all technical terms and scientific terms have the same meanings as those commonly understood by a person skilled in the art to which the present invention pertains. The terms used herein are only for effectively describing a certain exemplary embodiment, and are not intended to limit the present invention.

### Example 1

0.2 g of Xylok resin (KOLON Industry) was dissolved in an acetone solvent (2 mL) to prepare a coating solution having a concentration of 2 M, and then SiOₓ (Sigma Aldrich) powder was mixed with the prepared coating solution so that a weight ratio of the coating solution: the Sio, powder was 1:10, and then stirring was performed for 20 minutes under a speed condition of 300 rpm to prepare a mixture.

Thereafter, the prepared mixture was dried in a vacuum oven at 110° C. for 2 hours, heated to 1000° C. at a heating rate of 3° C./min under an argon gas atmosphere, and heat treated for 1 hour to manufacture a composite (negative electrode active material) in which a carbon coating layer was formed on the surface of a silicon oxide by carbonization of the Xylok resin.

### Example 2

A composite was manufactured in the same manner as in Example 1, except that mixing the composite obtained in Example 1 instead of the SiOₓ powder with the coating solution to prepare a mixture, and drying and then heat treating the mixture were performed once as a unit process to manufacture a composite on which a carbon coating layer was formed.

### Example 3

A composite was manufactured in the same manner as in Example 1, except that mixing the composite obtained in Example 1 instead of the SiOₓ powder with the coating solution to prepare a mixture, and drying and then heat treating the mixture were performed twice as a unit process to manufacture a composite on which a carbon coating layer was formed.

### Example 4

A composite was manufactured in the same manner as in Example 1, except that mixing the composite obtained in Example 1 instead of the SiOₓ powder with the coating solution to prepare a mixture, and drying and then heat treating the mixture were performed three times as a unit process to manufacture a composite on which a carbon coating layer was formed.

### Comparative Example 1

SiOₓ (Sigma Aldrich) powder itself was applied as the negative electrode active material.

### Comparative Example 2

SiOₓ (Sigma Aldrich) powder was added to a chemical vapor deposition (CVD) chamber, and toluene gas was supplied to manufacture a negative electrode active material in which a carbon coating layer was formed on the surface of the silicon oxide powder.

### Comparative Example 3

The process was performed in the same manner as in Example 1, except that 2, 3-dihydroxylnaphthalene solution in which 2, 3-dihydroxynaphthalene was dissolved in 50 parts by weight of ethanol was used instead of the coating solution of Example 1.

### Comparative Example 4

The process was performed in the same manner as in Example 1, except that the mixture prepared in Example 1 was directly heat treated without a drying process.

### (Experimental Example 1) Analysis of Characteristics Of Negative Electrode Active Material

The characteristics of each of the prepared negative electrode active materials were analyzed by performing X-ray diffraction (XRD) analysis, transmission electron microscope (TEM), and Raman spectrum analysis experimentation.

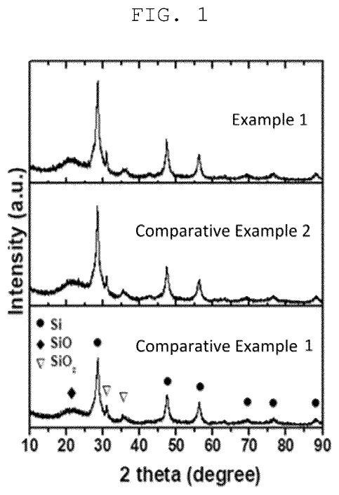

The results of XRD analysis of the negative electrode active materials manufactured according to Comparative Examples 1 and 2 and Example 1 are shown in FIG. 1.

As shown in FIG. 1, it was confirmed that the XRD patterns of Example 1 and Comparative Example 2 on which the carbon coating layer was formed were almost similar to the XRD pattern of Comparative Example 1 which did not include the carbon coating layer, and it was found therefrom that the crystal structure of the silicon oxide which was a core material was not affected by the formation of the carbon coating layer.

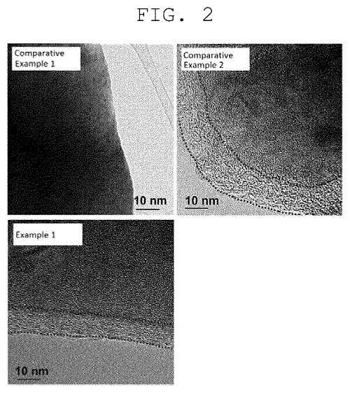

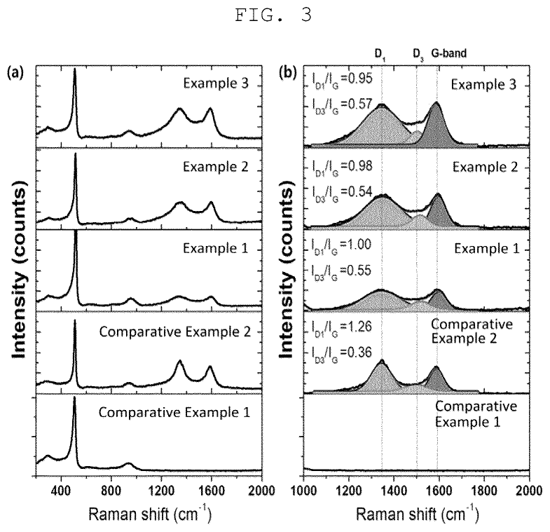

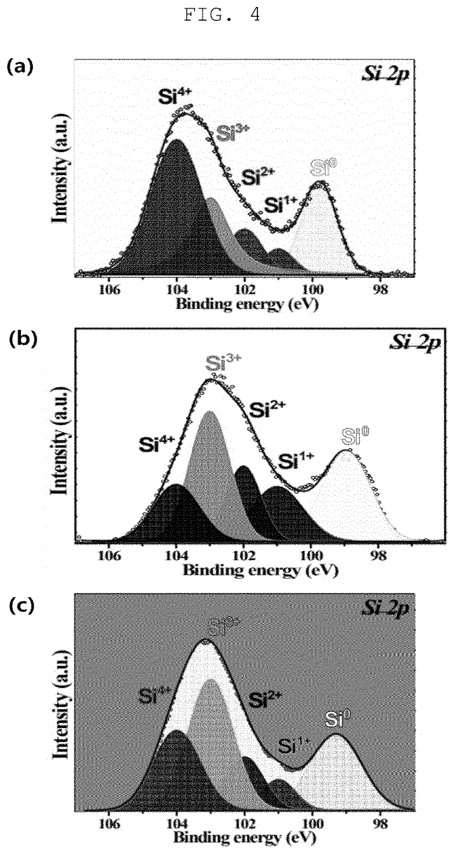

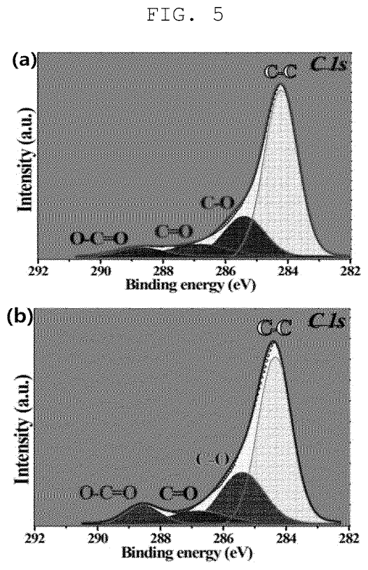

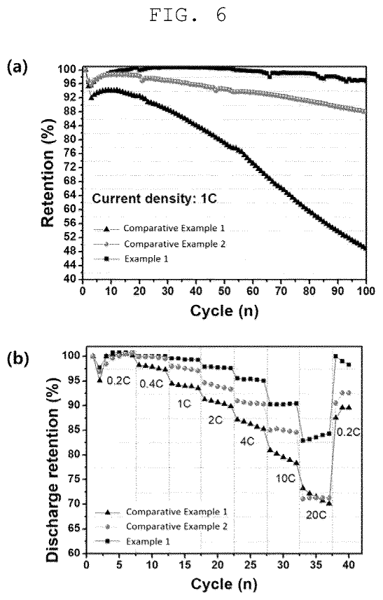

FIG. 2 is drawings showing TEM images of the negative electrode active material manufactured according to Comparative Examples 1 and 2 and Example 1.

As shown in the TEM images of FIG. 2, it was confirmed that in the negative electrode active materials of Comparative Example 2 and Example 1, the carbon coating layer (red dotted area) was formed on the silicon oxide core. It was confirmed that the thicknesses of the carbon coating layers included in the negative electrode active materials of Comparative Example 2 and Example 1 were formed to be 10 nm and 12 nm, respectively, and it was observed that the thickness uniformity was better in Example 1 than in Comparative Example 2.

Though not shown in the drawing, it was observed that the carbon coating layer was formed on all of the negative electrode active materials of Examples 2 to 4 and Comparative Examples 3 and 4, and it was confirmed that the average thicknesses of the formed carbon coating layer were 15 nm, 23 nm, 29 nm, 11 nm, and 11.5 nm, respectively. Regarding the thickness uniformity of the formed carbon coating layer, it was observed that the carbon coating layers included in the negative electrode active materials of Examples 2 to 4 had excellent thickness uniformity, like Example 1, but Comparative Examples 3 and 4 had relatively deteriorated thickness uniformity.

Additionally, the carbon content included in each negative electrode active material was measured by CS element analysis, and the results are summarized in the following Table 1:

TABLE 1

| | Carbon, wt % |
|---|---|
| Comparative Example 1 | 0 |
| Comparative Example 2 | 3.5 |
| Example 1 | 2.7 |
| Example 2 | 5.8 |
| Example 3 | 8.6 |

(a) and (b) of FIG. 3 are drawings showing Raman spectrum measured for each of the carbon coating layers included in the negative electrode active materials of Comparative Examples 1 and 2 and Examples 1 to 3, and results of the Raman spectrum showing deconvoluted peaks fitted from the measured Raman spectrum.

As shown in (a) of FIG. 3, since all of the negative electrode active materials of Comparative Example 2 and Examples 1 to 3 excluding Comparative Example 1 included the carbon coating layer, it was found that the peak was positioned in a wave number range of 1250 to 1650 cm⁻¹.

Upon detailed review referring to (b) of FIG. 3, it was found that the central peak intensity I_{D1} of a D1 band having the peak center positioned in the wave number range of 1350±20 cm⁻¹, the central peak intensity I_{D3} of a D3 band having the peak center positioned in the wave number range of 1500±10 cm⁻¹, and the central peak intensity I_{G} of a G band having the peak center positioned in the wave number range of 1580±20 cm⁻¹, of the negative electrode active materials of Comparative Example 2 and Examples 1 to 3 were different.

First, upon comparison of a ratio between I_{D1} and I_{G} (I_{D1}/I_{G}, hereinafter, referred to as R₁), the R₁ value of Comparative Example 2 was 1.26, showing that the central peak intensity of the D1 band shown by the disorder of sp2 carbon was higher than the central peak intensity of the G band, while the R₁ values of Examples 1 to 3 were 1.00, 0.98, and 0.95, respectively, showing that the central peak intensity of the D1 band and the central peak intensity of the G band were almost similar.

Additionally, upon comparison of a ratio between I_{D3} and I_{G} (I_{D3}/I_{G}, hereinafter, referred to as R₂), it was confirmed that the R₂ value of Comparative Example 2 was 0.36, while the R₂ values of Examples 1 to 3 were 0.55, 0.54, and 0.57, respectively, which were different from the R₂ value of Comparative Example 2.

Though not shown in the drawing, the R₁ value and the Re value of Example 4 were confirmed to be 0.91 and 0.60, respectively, and the R₁ value and the R₂ value of Comparative Example 3 were confirmed to be 1.29 and 0.32, respectively, similarly to Comparative Example 2.

Subsequently, the surface chemical properties of Example 1 and Comparative Examples 1 and 2 were compared and analyzed, using X-ray photoelectron spectroscopy (XPS).

(a), (b), and (c) of FIG. 4 are drawings showing high resolution Si 2P XPS profiles including deconvoluted peaks corresponding to silicon having an oxidation number of 0, 1, 2, 3, and 4 for the negative electrode active materials of Example 1 and Comparative Examples 1 and 2, respectively.

Referring to (a), (b), and (c) of FIG. 4, it was found that the negative electrode active materials of Example 1 and Comparative Examples 1 and 2 included the deconvoluted peaks corresponding to silicon having the oxidation number of 1, 2, 3, and 4 which showed a maximum intensity value at binding energy of 101 eV, 102 eV, 103 eV, and 104 eV, respectively, and a deconvoluted peak corresponding to silicon having the oxidation number of 0 which showed a maximum intensity value in a binding energy range of 99 to 100 eV, and each atom % of silicon having different oxidation numbers is summarized in the following Table 2.

TABLE 2

| | at % | | | | |
|---|---|---|---|---|---|
| | Si⁰ | Si¹⁺ | Si²⁺ | Si³⁺ | Si⁴⁺ |
| Example 1 | 19.2 | 4.8 | 9.9 | 24.5 | 41.6 |
| Comparative Example 1 | 21.1 | 14.6 | 22.5 | 26.3 | 15.5 |
| Comparative Example 2 | 23.5 | 6.2 | 12.1 | 35.7 | 22.6 |

As shown in Table 2, it was confirmed that silicon having the oxidation number of 4 of Example 1 was 41.6 at %, which was a significantly higher content than Comparative Example 1 (15.5 at %) and Comparative Example 2 (22.6 at %). In addition, upon comparison of the ratio (A₄/A₁) of the atom % (A₄) of silicon having the oxidation number 4 to the atom % (A₁) of silicon having the oxidation number of 1, Example 1 was confirmed to have the value of 8.66, while Comparative Examples 1 and 2 were confirmed to have the values of 1.06 and 3.65, respectively.

(a) and (b) of FIG. 5 are drawings showing high resolution C 1s XPS profiles including deconvoluted peaks in the negative electrode active materials of Example 1 and Comparative Example 2, respectively.

As shown in (a) and (b) of FIG. 5, it was found from the deconvoluted peaks that carbon included a sp² bond structure (C—C; 284.3 eV) and a sp³ bond structure (C—O, C═0, and O—C═O; 285.5 eV, 286.8 eV, and 288.7 eV), and each atom % of carbon having the bond structures is summarized in the following Table 3.

TABLE 3

at %

| | C—C | C—O | C═O | O—C═O |
|---|---|---|---|---|
| Example 1 | 67.9 | 19.8 | 6.9 | 5.4 |
| Comparative Example 2 | 61.9 | 24.7 | 6.2 | 7.2 |

As summarized in Table 3, it was found that carbon having the sp² bond structure was 67.9 at % in Example 1, but 61.9 at % in Comparative Example 2. The negative electrode active material of Example 1 which included more carbon having a sp² bond structure was able to improve the electrical conductivity properties on the surface of the negative electrode active material.

In addition, upon comparison of the ratio of the content (at %) of carbon having a C—C bond structure to the content (at %) of carbon having a O—C═O bond structure having the highest binding energy, Example 1 had 12.6, while Comparative Example 2 had 8.6, which were found to be significantly different.

### (Experimental Example 2) Analysis of Characteristics of Secondary Battery Including Each Negative Electrode Active Material

In order to evaluate an effect on the characteristics of the secondary battery depending on a difference in the crystallographic properties (Raman properties) of the carbon coating layer formed on the silicon oxide core, each of the negative electrode active material, denka black, carboxymethyl cellulose (CMC), and styrene butadiene rubber (SBR) were mixed at a weight ratio of 6:2:1:1 in distilled water to prepare a negative electrode active material slurry, and then the prepared negative electrode active material slurry was coated on one surface of a copper current collector at a thickness of 50 μm and dried. After the drying, it was punched with a diameter of 14 mm to manufacture a negative electrode.

A lithium metal was used as a counter electrode, a polyolefin separator was interposed between the negative electrode and the lithium metal, and then an electrolyte solution was injected to manufacture a coin type half battery. At this time, the electrolyte solution was an electrolyte solution in which 1 M LiPF₆ was dissolved in a mixed solvent of ethylene carbonate (EC)/diethyl carbonate (DEC) at a volume ratio of 1:1.

The charge and discharge characteristics of the coin type half batteries including the negative electrode active materials of Comparative Examples 1 and 2 and Example 1 were compared and analyzed.

(a) and (b) of FIG. 6 are drawings showing results of charge and discharge cycle life characteristics and rate properties, respectively. At this time, the cycle life experiment was performed for 100 cycles with one cycle of charge and discharge with a constant current of 1 C, and the rate properties were analyzed sequentially every 5 cycles under different current density conditions of 0.2 C, 0.4 C, 1 C, 2 C, 4 C, 10 C, 20 C, and 0.2 C.

Referring to (a) of FIG. 6, the capacity retention rate of the coin type half battery including the negative electrode active material of Example 1 after 100 cycles of charge and discharge was about 97%, and it was confirmed that Example 1 had significantly excellent cycle life characteristics, considering the capacity retention rate of Comparative Example 1 (about 48%) and the capacity retention rate of Comparative Example 2 (about 88%).

Though not shown in the drawing, it was confirmed that the cycle life characteristics of the coin type half batteries including the negative electrode active materials of Examples 2 and 3 were also shown to be similar to Example 1, and the capacity retention rate of the coin type half battery including the negative electrode active material of Example 4 was about 938, while the capacity retention rates of the coin type half batteries including the negative electrode active materials of Comparative Examples 3 and 4 were about 82% and about 89%, respectively, which were inferior to the cycle life characteristics of the coin type half batteries including the negative electrode active materials of Examples 1 and 4.

It was found therefrom that the Raman properties of the negative electrode active material and the uniform carbon coating layer formed on the surface of the negative electrode active material described above affect the characteristics of the secondary battery.

As shown in (b) of FIG. 6, it was confirmed that similar results were also shown for the rate properties, like the charge and discharge cycle life characteristics.

In particular, the discharge capacity retention rate of the coin type half battery including the negative electrode active material of Example 1 was about 83% even at a high rate of 20 C, and it was observed that Example 1 showed significantly excellent rate properties, as compared with the discharge capacity retention rates (about 72%) of Comparative Examples 1 and 2.

Hereinabove, although the present invention has been described by the specific matters and specific exemplary embodiments, they have been provided only for assisting in the entire understanding of the present invention. Therefore, the present invention is not limited to the exemplary embodiments, and various modifications and changes may be made by those skilled in the art to which the present invention pertains from this description. Therefore, the spirit of the present invention should not be limited to the above-described exemplary embodiments, and the following claims as well as all modifications equal or equivalent to the claims are intended to fall within the scope and spirit of the invention.

1. A negative electrode active material comprising:
a core including a porous silicon-based material; and
a coating layer including amorphous carbon coated on a surface of the core,
wherein the coating layer satisfies the following Relation Expression 1:
$$1 < {R}_{1} / {R}_{2} < 3 \qquad ( Relational Expression 1 )$$
wherein R₁ is a ratio (I_{D1}/I_{G}) of a central peak intensity I_{D1} of a D1 band and a central peak intensity I_{G} of a G band, and R₂ is a ratio (I_{D3}/I_{G}) of a central peak intensity I_{D3} of a D3 band and the central peak intensity I_{G} of the G band, the D1 band having a peak center positioned in a wave number range of 1350±20 cm⁻¹, the G band having a peak center positioned in a wave number range of 1580±20 cm⁻¹, and the D3 band having a peak center positioned in a wave number range of 1500±10 cm⁻¹, in a Raman spectrum.

2. The negative electrode active material of claim 1, wherein the amorphous carbon is derived from a resin having a repeating unit containing an arylene group.

3. The negative electrode active material of claim 2, wherein the resin has a repeating unit containing one or more phenolic hydroxyl groups.

4. The negative electrode active material of claim 3, wherein a hydroxyl group equivalent included in the resin is 150 to 300 g/eq.

5. The negative electrode active material of claim 1, wherein R₁ is 0.9 to 1.05.

6. The negative electrode active material of claim 1, wherein R₂ is 0.5 to 0.6.

7. The negative electrode active material of claim 1, wherein the silicon-based material includes at least one material of silicon (Si), a silicon oxide (SiOₓ(0<x≤2)), a silicon alloy, or a combination thereof.

8. The negative electrode active material of claim 7, wherein the silicon-based material includes 30 at % or more of silicon having an oxidation number of 4 in a Si 2P XPS spectrum of the negative electrode active material including deconvoluted peaks corresponding to silicon having the oxidation number of 0, 1, 2, 3, and 4.

9. The negative electrode active material of claim 8, wherein the silicon-based material satisfies the following Relation Expression 2:
$${A}_{4} / {A}_{1} \geq 4 \qquad ( Relational Expression 2 )$$
wherein A₄ is the atom % of silicon having an oxidation number of 4, and A₁ is the atom % of silicon having an oxidation number of 1, in the Si 2P XPS spectrum of the negative electrode active material.

10. The negative electrode active material of claim 1, wherein the coating layer has a thickness of 5 to 30 nm.

11. The negative electrode active material of claim 1, wherein the core has an average diameter of 0.1 to 50 μm.

12. A negative electrode for a secondary battery comprising the negative electrode active material of claim 1.

13. A method for manufacturing a negative electrode active material, the method comprising:
a) preparing a coating solution including a resin having a repeating unit containing an arylene group and a solvent, for forming a coating layer including amorphous carbon;
b) preparing a first mixture of porous silicon-based powder in the coating solution; and
c) drying and then heat treating the first mixture.

14. The method for manufacturing a negative electrode active material of claim 13, wherein the coating solution has a viscosity of 5 to 200 cP.

15. The method for manufacturing a negative electrode active material of claim 13, wherein a weight ratio of the coating solution: the silicon-based powder included in the first mixture is 1:8 to 15.

16. The method for manufacturing a negative electrode active material of claim 13, wherein the resin included in the coating solution has a repeating unit containing one or more phenolic hydroxyl groups.

17. The method for manufacturing a negative electrode active material of claim 13, wherein the heat treating of c) is performed in a temperature condition of 900 to 1100° C. under an inert gas atmosphere.

18. The method for manufacturing a negative electrode active material of claim 13, wherein using a product obtained after the heat treating of c),
a unit process including: b-1) preparing a second mixture of the product in the coating solution; and
c-1) drying and then heat treating the second mixture is performed once or more.

19. The method for manufacturing a negative electrode active material of claim 18, wherein in a first coating layer of the product obtained after c) to an N^{th} coating layer of the product obtained by performing the unit process n times or more, standard deviations of an R₁ value and an R₂ value of the first coating layer to the N^{th} coating layer are less than 0.1, respectively,
wherein R₁ is a ratio (I_{D1}/I_{G}) of a central peak intensity I_{D1} of a D1 band and a central peak intensity I_{G} of a G band, and R₂ is a ratio (I_{D3}/I_{G}) of a central peak intensity I_{D3} of a D3 band and the central peak intensity I_{G} of the G band, the D1 band having a peak center positioned in a wave number range of 1350±20 cm⁻¹, the G band having a peak center positioned in a wave number range of 1580±20 cm⁻¹, and the D3 band having a peak center positioned in a wave number range of 1500±10 cm⁻¹, in a Raman spectrum.
